(19) United States
(12) Patent Application Publication
(10) Pub. No.: US 2025/0234865 A1
(43) Pub. Date: Jul. 24, 2025

(54) Additive Composition for Antifouling Coatings

(71) Applicant: ARXADA, LLC, Morristown, NJ (US)

(72) Inventors: Kevin Janak, Blauvelt, NY (US); Brittany Caldwell, Gainesville, GA (US); Shruti Agarkar, Alpharetta, GA (US); Yoshiyuki Iwase, Nasushiobara-shi, Tochigi-ken (JP)

(21) Appl. No.: 18/700,756

(22) PCT Filed: Oct. 14, 2022
(86) PCT No.: PCT/US2022/046656

§ 371 Date: Apr. 12, 2024

Related U.S. Application Data
(60) Provisional application No. 63/256,207, filed on Oct. 15, 2021.

(51) Int. Cl. A01N 55/02; A01N 43/80; A01N 59/20; C09D 5/14; C09D 5/16; C09D 7/62; C09D 7/63; C09D 127/06; C09D 193/04

(52) U.S. Cl. CPC A01N 55/02; A01N 43/80; A01N 59/20; C09D 5/14; C09D 5/1625; C09D 7/62; C09D 7/63; C09D 127/06; C09D 193/04

(57) ABSTRACT

The present disclosure is generally directed to an additive composition for an antifouling coating. The additive composition includes a superhydrophobic film modifier and a biocide potentiator that includes one or both of a compound IA and a compound IB. The additive composition may be used for inhibiting marine biofouling. Antifouling paints including the additive composition are also provided.

### BACKGROUND

Ships, aquaculture fishnets, underwater structures, and underwater equipment are frequently targeted by marine organisms, such as barnacles, bryozoans, hydroids, mussels, algae, and the like. Such organisms can grow, multiply, and eventually cause significant problems. For example, in the case of a ship's hull, growth of marine organisms on the hull can increase frictional resistance between the hull and water, thus increasing fuel consumption and reducing the speed of the ship. Ship hulls need to be protected against the growth of marine organisms in order to keep the hulls clean and smooth for maximum fuel efficiency. Transporting marine organisms from one part of the world to another can also introduce foreign organisms and disrupt a local ecosystem. Thus, adequate protection against marine biofouling is advantageous for underwater parts.

Antifouling paints are frequently added to underwater parts to limit marine biofouling. The binder systems used for such antifouling paints generally include an erodible binder. Erosion of the paint film aids in preventing fouling by releasing biocidal agents from the coating over time thus impeding attachment of marine organisms. There are two main types of erodible antifouling coatings, self-polishing and ablative.

The binder system of ablative coatings includes mostly rosin which reacts with sea water to become water soluble and erode. Alternatively, rosin or rosin derivatives are also used in mixtures with non-erodible binders, such as polyester resin, acrylic resin, epoxy resin, vinyl chloride resin, chlorinated rubber resin, chlorinated polyethylene resin, chlorinated polypropylene resin, styrene-butadiene resin, or polyamide resin. In self-polishing antifouling coatings, the binder system includes mostly hydrolysable acrylate polymers. The hydrolysable functionality is commonly provided to the polymer by either a metal carboxylate acrylate monomer or a silyl acrylate monomer. Erodible polyester binders are also used and result in lower cost antifouling paints. The difference between ablative and self-polishing coatings lies mainly in the thickness of the leached layer and the more linear rate of erosion over time for the self-polishing coating. Hybrid coatings also exist whose binder systems include an erodible acrylate, such as in self-polishing paints, and rosin. The thickness of the leached layer is thinner than in ablative coatings but thicker than in true self-polishing coatings.

Most commercially available antifouling paints contain a high metal content due to the high concentration of cuprous oxide (Cu₂O) used as the biocidal agent, typically about forty percent by weight, which is required for appropriate antifouling protection. Cuprous oxide is potentially harmful to many organisms, and leaching from antifouling paints can contribute to elevated copper levels in water, sediments, and surrounding environments. Artificial high copper levels may have a significant ecological impact. While cuprous oxide is widely used as antifouling agent in antifouling paints, antifouling paints can also contain additional biocidal agents because cuprous oxide alone is generally only effective against hard fouling organisms, like barnacles.

Therefore, there is a need for ecologically and economically improved antifouling paints with reduced biocidal agent content. Reducing copper content would be particularly useful.

### SUMMARY

In general, the present disclosure is directed to additive compositions, e.g., for use with antifouling coatings. The additive compositions include a superhydrophobic film modifier and a biocide potentiator. Advantageously, the additive compositions of the present disclosure can increase efficacy of a biocidal agent, such as cuprous oxide (Cu₂O), and thus decrease the concentration of biocidal agent required for appropriate antifouling protection. The additive compositions may enhance the antifouling performance of all types of antifouling paints, such as ablative, self-polishing, and hybrid paints, and may also be used in simple contact leaching coatings. The improved antifouling performance provided by the additive compositions is particularly surprising because antifouling paints with the additive compositions may not be superhydrophobic, e.g., despite the presence of the superhydrophobic film modifier within the antifouling paints.

An additive composition for an antifouling coating according to example implementations of the present disclosure includes a superhydrophobic film modifier and a biocide potentiator. The biocide potentiator includes one or both of a compound IA and a compound IB. The formula of compound IA may be

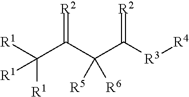

and the formula of compound IB may be

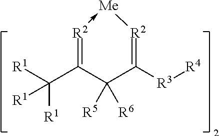

wherein Me may be Cu, Zn, Co, Ni, Ca, Mg, or Mn,
wherein R1 may each be independently selected from hydrogen, halogen, linear or branched C₁₋₂₀ alkyl, C₂₋₂₀ alkenyl, C₂₋₂₀ alkynyl, C₃₋₁₂ cycloalkyl, C₆₋₂₀ aryl, and C₇₋₂₀ arylalkyl.
wherein R2 may each be independently selected from NH, O, S, and Se. R3 may be NH, N(R4), O, S, or Se,
wherein R4 may be hydrogen, linear or branched C₁₋₂₀ alkyl, C₂₋₂₀ alkenyl, C₂₋₂₀ alkynyl, C₃₋₁₂ cycloalkyl, C₆₋₂₀ aryl, or C₇₋₂₀ arylalkyl,
wherein R5 and R6 may each be independently selected from H, linear or branched C₁₋₂₀ alkyl, C₂₋₂₀ alkenyl, C₂₋₂₀ alkynyl, C₃₋₁₂ cycloalkyl, C₆₋₂₀ aryl, and C₇₋₂₀ arylalkyl, or R5 and R6 may together form a group ═O, ═S, ═Se, ═NR4, ═C(R4) 2, ═C(R4)(OR4), ═C(R4)(NHR4).

In a first example aspect: Me may be Cu or Zn; R1 may each be independently selected from H, F, methyl, ethyl, n-propyl, i-propyl, n-butyl, i-butyl, tert-butyl, cyclo-butyl, cyclo-pentyl, cyclo-hexyl, C₈ alkyl, C₉ alkyl, C₁₀ alkyl, C₁₁ alkyl, C₁₂ alkyl, and benzyl; R2 may each be independently selected from NH and O; R3 is N(R4) or O; R4 may be H, methyl, ethyl, n-propyl, i-propyl, n-butyl, i-butyl, tert-butyl, cyclo-butyl, cyclo-pentyl, cyclo-hexyl, C₈ alkyl, C₉ alkyl, C₁₀ alkyl, C₁₁ alkyl, C₁₂ alkyl, or benzyl; and R5 and R6 may each be independently selected from H, methyl, ethyl, n-propyl, i-propyl, n-butyl, i-butyl, tert-butyl, and benzyl, or R5 and R6 may together form a group ═CH(OCH₃), ═CH(OC₂H₅), ═CH(OnC₃H₇), ═CH(OiC₃H₇), ═CH(OnC₄H₉), ═CH(OiC₄H₉), ═CH(OtertC₄H₉), ═CH(NHCH₃), ═CH(NHC₂H₅), ═CH(NHnC₃H₇), ═CH(NHiC₃H₇), ═CH(NHnC₄H₉), ═CH(NHiC₄H₉), or ═CH(NHtertC₄H₉).

In a second example aspect, a ratio of the superhydrophobic film modifier to the biocide potentiator by weight is from 10:1 to 1:10, preferably from 5:1 to 1:5, and most preferably from 3:1 to 1:3.

In a third example aspect, the additive composition further includes a biocidal agent. The biocidal agent may include one or more of copper 2-pyridinethiol-1-oxide (copper pyrithione, CuPT), zinc 2-pyridinethiol-1-oxide (zinc pyrithione, ZnPT), 4,5-dichloro-2-n-octyl-4-isothiazolin-3-one (DCOIT), cuprous oxide (Cu₂O), zinc oxide (ZnO), 4-bromo-2-(4-chlorophenyl)-5-(trifluoromethyl)-1H-pyrrole-3-carbonitrile (tralopyril), zinc ethane-1,2-diylbis(dithiocarbamate)(zineb), zinc N,N-dimethylcarbamodithioate (ziram), 3-(3,4-dichlorophenyl)-1,1-dimethylurea (diuron), copper (I) thiocyanate (CuSCN), 4-[1-(2,3-dimethylphenyl)ethyl]-1H-imidazole (medetomidine), triazines, fluanids, and 2,4,5,6-tetrachloroisophthalonitrile (chlorothalonil). A ratio of the biocide potentiator to the biocidal agent by weight may be from 10:1 to 1:10, preferably from 5:1 to 1:5, and most preferably from 1:1 to 1:3.

In a fourth example aspect, the superhydrophobic film modifier may include porous diatomaceous earth particles coated with a hydrophobic layer.

Each of the example aspects recited above may be combined with one or more of the other example aspects recited above in certain embodiments. For instance, all of the first, second, third, and fourth example aspects recited above may be combined with one another in some embodiments. As another example, any combination of two or three of the first, second, third, and fourth example aspects recited above may be combined in other embodiments. Thus, the example aspects recited above may be utilized in combination with one another in some example embodiments.

In a fifth example aspect, a method is provided that includes using the additive composition for inhibition of marine biofouling on a solid surface. The antifouling composition may be used in combination with a polymer, a copolymer, or both the polymer and the copolymer to allow controlled release of the one or more of the superhydrophobic film modifier, the biocide potentiator, and the biocidal agent.

In a sixth example aspect, an antifouling paint includes the additive composition and a polymer, a copolymer, or both the polymer and the copolymer to allow controlled release of one or more of the superhydrophobic film modifier, the biocide potentiator, and the biocidal agent. The biocide potentiator may be present in the antifouling paint from about 0.2 wt % to about 20 wt %, preferably from about 0.5 wt % to about 10 wt %, and more preferably from about 1 wt % to about 5 wt %. The biocidal agent may be present in the antifouling paint at less than about 30 wt %. The superhydrophobic film modifier may be present in the antifouling paint from about 0.2 wt % to about 20 wt %, preferably from about 0.5 wt % to about 10 wt %, and more preferably from about 1 wt % to about 5 wt %. The antifouling paint may not be superhydrophobic.

In a seventh example aspect, a method for inhibiting marine biofouling on a solid surface includes applying the antifouling paint onto the solid surface.

Other features and aspects of the present disclosure are discussed in greater detail below.

### DETAILED DESCRIPTION

It is to be understood by one of ordinary skill in the art that the present disclosure is a description of exemplary embodiments only and is not intended as limiting the broader aspects of the present disclosure.

The present disclosure is generally directed to an additive composition for an antifouling coating. The additive composition includes a superhydrophobic film modifier a biocide potentiator. The additive composition may be included in an antifouling paint that also includes one or more biocidal agents. The antifouling paint may inhibit the fouling of surfaces of underwater objects, such as ship hulls or any other marine structures. Results have demonstrated that the addition of the additive composition can produce a potentiator or adjuvant effect that improves the efficacy of known biocidal agents, while demonstrating no significant biocidal activity alone. Moreover, the superhydrophobic film modifier in combination with the biocide potentiator may advantageously increase an efficacy of a biocidal agent in the antifouling paint. In particular, it has been surprisingly found that the superhydrophobic film modifier in combination with the biocide potentiator significantly enhances the antifouling efficacy of the biocidal agent in the antifouling paint against the settling of marine organisms, such as barnacles, bryozoans, hydroids, mussels, algae, and the like. This surprising result can allow for the formulation of antifouling paints that include lower amounts of the biocidal agents, such as cuprous oxide (Cu₂O), mitigating at least some of the environmental concerns associated with such products.

The biocide potentiator includes one or both of a compound of formula IA and a compound of formula IB. Compound IA has the following formula

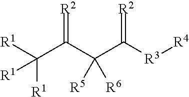

and compound IB has the following formula

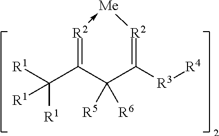

wherein Me is Cu, Zn, Co, Ni, Ca, Mg, or Mn, wherein R1 is each independently selected from hydrogen, halogen, linear or branched C₁₋₂₀ alkyl, C₂₋₂₀ alkenyl, C₂₋₂₀ alkynyl, C₃₋₁₂ cycloalkyl, C₆₋₂₀ aryl, and C₇₋₂₀ arylalkyl, wherein R2 is each independently selected from NH, O, S, and Se, wherein R3 is NH, N(R4), O, S, or Se, wherein R4 is hydrogen, linear or branched C₁₋₂₀ alkyl, C₂₋₂₀ alkenyl, C₂₋₂₀ alkynyl, C₃₋₁₂ cycloalkyl, C₆₋₂₀ aryl, or C₇₋₂₀ arylalkyl, and wherein R5 and R6 are each independently selected from H, linear or branched C₁₋₂₀ alkyl, C₂₋₂₀ alkenyl, C₂₋₂₀ alkynyl, C₃₋₁₂ cycloalkyl, C₆₋₂₀ aryl, and C₇₋₂₀ arylalkyl, or R5 and R6 together form a group ═O, ═S, ═Se, ═NR4, ═C(R4) 2, ═C(R4)(OR4), ═C(R4)(NHR4).

In certain example embodiments: Me may be Cu or Zn; R1 may each be independently selected from H, F, methyl, ethyl, n-propyl, i-propyl, n-butyl, i-butyl, tert-butyl, cyclo-butyl, cyclo-pentyl, cyclo-hexyl, C₈ alkyl, C₉ alkyl, C₁₀ alkyl, C₁₁ alkyl, C₁₂ alkyl, and benzyl; R2 may each be independently selected from NH and O; R3 is N(R4) or O; R4 may be H, methyl, ethyl, n-propyl, i-propyl, n-butyl, i-butyl, tert-butyl, cyclo-butyl, cyclo-pentyl, cyclo-hexyl, C₈ alkyl, C₉ alkyl, C₁₀ alkyl, C₁₁ alkyl, C₁₂ alkyl, or benzyl; and R5 and R6 may each be independently selected from H, methyl, ethyl, n-propyl, i-propyl, n-butyl, i-butyl, tert-butyl, and benzyl, or R5 and R6 may together form a group ═CH(OCH₃), ═CH(OC₂H₅), ═CH(OnC₃H₇), ═CH(OiC₃H₇), ═CH(OnC₄H₉), ═CH(OiC₄H₉), ═CH(OtertC₄H₉), ═CH(NHCH₃), ═CH(NHC₂H₅), ═CH(NHnC₃H₇), ═CH(NHiC₃H₇), ═CH(NHnC₄H₉), ═CH(NHiC₄H₉), or ═CH(NHtertC₄H₉).

In a particular example embodiment, in the compound IB, Me is Cu, each R1 is F, each R2 is O, R3 is O, R5 and R6 are each H, and R4 is not ethyl.

Suitable compounds of formula IA and IB, respectively, include, for example: ethyl 3-amino-4,4,4-trifluorocrotonate; [ethyl 3-amino-4,4,4-trifluorocrotonate]₂Zn; [ethyl 3-amino-4,4,4-trifluorocrotonate]₂Cu; ethyl 3-amino-2-methylene-(methylamino)-4,4-difluorocrotonate; [ethyl 3-amino-2-methylene-(methylamino)-4,4-difluorocrotonate]₂Zn; [ethyl 3-amino-2-methylene-(methylamino)-4,4-difluorocrotonate]₂Cu; 4,4,4-trifluoro-N, N-dimethyl-3-oxobutanamide; [4,4,4-trifluoro-N, N-dimethyl-3-oxobutanamide]₂Cu; [4,4,4-trifluoro-N, N-dimethyl-3-oxobutanamide]₂Zn; dodecyl 4,4,4-trifluoro-3-oxobutanoate; [dodecyl 4,4,4-trifluoro-3-oxobutanoate]₂Zn; dodecyl 4,4,4-trifluoro-3-oxobutanoate]₂Cu; benzyl 4,4,4-trifluoroacetoacetate; [benzyl 4,4,4-trifluoroacetoacetate]₂Zn; [benzyl 4,4,4-trifluoroacetoacetate]₂Cu; octyl 4,4,4-trifluoroacetoacetate; [octyl 4,4,4-trifluoroacetoacetate]₂Zn; [octyl 4,4,4-trifluoroacetoacetate]₂Cu; isopropyl 4,4,4-trifluoroacetoacetate; [isopropyl 4,4,4-trifluoroacetoacetate]₂Zn; [isopropyl 4,4,4-trifluoroacetoacetate]₂Cu; ethyl 4,4,4-trifluoroacetoacetate; [ethyl 4,4,4-trifluoroacetoacetate]₂Zn; tert-butyl 4,4,4-trifluoro-3-oxobutanoate; [tert-Butyl 4,4,4-trifluoro-3-oxobutanoate]₂Zn; and [tert-butyl 4,4,4-trifluoro-3-oxobutanoate]₂Cu.

In certain example embodiments, the superhydrophobic film modifier may include superhydrophobic diatomaceous earth-derived powder. Moreover, porous diatomaceous earth particles may have surfaces and a continuous hydrophobic layer that conforms to and is bound to the surface of the diatomaceous earth particles. The diatomaceous earth particles may have the surface structure of uncalcined diatomaceous earth. The surface structure of diatomaceous earth may be highly partitioned with ridges and peaks extending outwardly from the particle. The hydrophobic layer may be a self-assembled monolayer (SAM) such that the topography of the diatomaceous earth particle is retained. The hydrophobic layers may include perfluorohydrocarbon moieties, such as a tridecafluorohexyl unit. As another example, the hydrophobic layer may include hexafluoropropene oxide oligomer moieties. Suitable superhydrophobic diatomaceous earth-derived powder is available from Dry Surface Technologies LLC and is described in U.S. Pat. No. 8,216,674, which is incorporated by reference in its entirety for all purposes.

In additive compositions according to example aspects of the present disclosure, the relative amounts of the superhydrophobic film modifier and the biocide potentiator may vary depending on, e.g., the nature of the superhydrophobic film modifier and the nature of the biocide potentiator. Advantageously, however, the weight ratio of the superhydrophobic film modifier to the biocide potentiator may be from 10:1 to 1:10, preferably from 5:1 to 1:5, and most preferably from 3:1 to 1:3. Such weight ratios have been advantageously found to increase an efficacy of a biocidal agent, such as cuprous oxide, when the additive compositions are incorporated into an antifouling paint, which allows for lower amounts of the biocidal agent as relative to antifouling paints without the additive compositions.

In certain example embodiments, the additive composition includes the superhydrophobic film modifier and the biocide potentiator, and the additive composition is substantially free of other materials. Thus, the additive composition may be a two-part additive composition in such example embodiments. The two-part additive composition may be provided as an ingredient for antifouling paints. Moreover, as described in greater detail below, the two-part additive composition may be subsequently added to other components to form an antifouling paint that includes the additive composition. As noted above, the additive composition may advantageously increase an efficacy of a biocidal agent, such as cuprous oxide, in the antifouling paint.

The additive compositions according to example aspects of the invention may further include one or more biocidal agents capable of preventing fouling on the surface of an object. Such biocidal agents may be inorganic biocidal agents, organometallic biocidal agents, or organic biocidal agents.

Examples of inorganic biocidal agents are: copper and copper compounds such as copper oxides, e.g., cuprous oxide and cupric oxide; copper alloys, e.g., copper-nickel alloys; copper salts, e.g., copper thiocyanate (CuSCN), copper sulphide; or barium metaborate.

Examples of organometallic biocidal agents are: zinc 2-pyridinethiol-1-oxide[ZnPT, zinc pyrithione]; organo-copper compounds, such as copper 2-pyridinethiol-1-oxide[CuPT, copper pyrithione], copper acetate, copper naphthenate, copper 8-uinolinonate [oxine-copper], copper nonylphenolsulfonate, copper bis(ethylenediamine)bis(dodecylbenzensulfonate), and copper bis(pentachlorophenolate); dithiocarbamate compounds, such as zinc N,N-dimethylcarbamodithioate [ziram], zinc ethane-1,2-diylbis(dithiocarbamate) [zineb], manganese ethylenebis(dithiocarbamate) [maneb], or manganese ethylenebis(dithiocarbamate) complexed with zinc salt [mancozeb].

Examples of organic biocidal agents are: heterocyclic compounds, such as 2-(tert-butylamino)-4-(cyclopropylamin)-6-(methylthio)-1,3,5-triazine [cybutryne], 4,5-dichloro-2-n-octyl-4-isothiazolin-3-one [DCOIT], 1,2-benzisothiazolin-3-one [BIT], 2-(thiocyanatomethylthio)-1,3-benzothiazole [benthiazole], 3-benzo[b]thien-2-yl-5,6-dihydro-1,4,2-oxathiazine-4-oxide [bethoxazin], and 2,3,5,6-tetrachloro-4-(methylsulphonyl)pyridine; urea derivatives, such as 3-(3,4-dichlorophenyl)-1,1-dimethylurea [diuron]; amides and imides of carboxylic acids, sulphonic acids and sulphenic acids, such as N-(dichlorofluoromethylthio) phthalimide, N-dichlorofluoromethylthio-N′,N′-dimethyl-N-phenylsulfamide [dichlofluanid], N-dichlorofluoromethylthio-N′,N′-dimethyl-N-p-tolylsulfamide [tolylfluanide], and N-(2,4,6-trichlorophenyl) maleimide; other organic compounds, such as pyridine triphenylborane, amine triphenylborane, 3-iodo-2-propynyl-N-butylcarbamate [iodocarb], 2,4,5,6-tetrachloroisophthalonitrile [chlorothalonil], p-((diiodomethyl) sulphonyl) toluene, or 4-bromo-2-(4-chlorophenyl)-5-(trifluoromethyl)-1H-pyrrole-3-carbonitrile [tralopyril].

Other examples of biocidal agents are tetra-alkylphosphonium halogenides, guanidine derivatives, imidazole containing compounds, such as 4-[1-(2,3-dimethylphenyl)ethyl]-1H-imidazole [medetomidine] and derivatives, macrocyclic lactones including avermectins and derivatives thereof, such as ivermectin, or spinosyns and derivatives thereof, such as spinosad, or enzymes, such as oxidase, or proteolytically, hemicellulolytically, cellulolytically, lipolytically or amylolytically active enzymes.

In one example embodiment, the additive compositions according to example aspects of the invention include the superhydrophobic film modifier, the biocide potentiator, and one or more biocidal agents selected from the group consisting of copper 2-pyridinethiol-1-oxide (CuPT, copper pyrithione), zinc 2-pyridinethiol-1-oxide (ZnPT, zinc pyrithione), 4,5-dichloro-2-n-octyl-4-isothiazolin-3-one (DCOIT), cuprous oxide (Cu₂O), zinc oxide (ZnO), 4-bromo-2-(4-chlorophenyl)-5-(trifluoromethyl)-1H-pyrrole-3-carbonitrile (tralopyril), zinc ethane-1,2-diylbis(dithiocarbamate)(zineb), zinc N,N-dimethylcarbamodithioate (ziram), 3-(3,4-dichlorophenyl)-1,1-dimethylurea (diuron), copper (I) thiocyanate (CuSCN), 4-[1-(2,3-dimethylphenyl)ethyl]-1H-imidazole (medetomidine), triazines, fluanids, and 2,4,5,6-tetrachloroisophthalonitrile (chlorothalonil).

In additive compositions according to example aspects of the present disclosure, the relative amounts of the superhydrophobic film modifier, the biocide potentiator, and the biocidal agent may vary depending on, e.g., the nature of the superhydrophobic film modifier, the nature of the biocide potentiator, and the nature of the biocidal agent. Advantageously, however, the weight ratio of the biocide potentiator to the biocidal agent may be from 10:1 to 1:10, preferably from 5:1 to 1:5, and most preferably from 1:1 to 1:3. Additionally, the weight ratio of the superhydrophobic film modifier to the biocidal agent may be from 10:1 to 1:10, preferably from 5:1 to 1:5, and most preferably from 3:1 to 1:3. Such weight ratios have been advantageously found to increase an efficacy of a primary biocidal agent, such as cuprous oxide, when the additive compositions are incorporated into an antifouling paint, which allows for lower amounts of the primary biocidal agent as relative to antifouling paints without the additive compositions.

In certain example embodiments, the additive composition includes the superhydrophobic film modifier, the biocide potentiator, and a biocidal agent (e.g., that is not cuprous oxide), and the additive composition is substantially free of other materials. Thus, the additive composition may be a three-part additive composition in such example embodiments. The three-part additive composition may be provided as an ingredient for antifouling paints. Moreover, as described in greater detail below, the three-part additive composition may be subsequently added to other components to form an antifouling paint that includes the additive composition. As noted above, the additive composition may advantageously increase an efficacy of a biocidal agent, such as cuprous oxide, in the antifouling paint.

In the example embodiments with the three-part additive composition, the biocide potentiator may be present in the three-part additive composition from about 5 wt % to about 60 wt %, preferably from about 10 wt % to about 50 wt %, and more preferably from about 15 wt % to about 45 wt %. Additionally, the superhydrophobic film modifier may be present in the three-part additive composition from about 5 wt % to about 60 wt %, preferably from about 10 wt % to about 50 wt %, and more preferably from about 15 wt % to about 45 wt %. The biocidal agent (e.g., that is not cuprous oxide) may be present in the three-part additive composition from about 20 wt % to about 70 wt %, preferably from about 25 wt % to about 60 wt %, and more preferably from about 30 wt % to about 55 wt %. Such concentrations have been advantageously found to increase an efficacy of a primary biocidal agent, such as cuprous oxide, when the three-part additive composition is included in antifouling paints, which allows for lower amounts of a primary biocidal agent, such as cuprous oxide, relative to antifouling paints without the additive compositions.

Example aspects of the present invention further provide for the use of the additive compositions for the inhibition of marine biofouling on a solid surface. The solid surface may be any solid surface of underwater objects, such as ships, an aquaculture fishnet, an underwater structure and equipment, a tank, an offshore construction, a pipe, a net, a pier, a pile, a pillar, or the like.

The additive compositions according to example aspects of the invention may further be used in combination with a polymer and/or copolymer allowing the controlled release of one or more of the superhydrophobic film modifier, the biocide potentiator, and the biocidal agent, e.g., by releasing these components from an antifouling coating over time as is the case with self-polishing or ablative coatings.

The superhydrophobic film modifier and the biocide potentiator are versatile agents that may be used in all types of antifouling coatings, e.g., in antifouling coatings based on various different polymers and/or copolymers typically used as binders for antifouling coating compositions. Thus, the polymers and/or copolymers allowing the controlled release of one or more of the superhydrophobic film modifier, the biocide potentiator, and the biocidal agent may be any polymers and/or copolymers typically used as binder in antifouling coatings. Suitable polymers and/or copolymers for that purpose are known to the person skilled in the art. Depending on the amount and kind of binder used, one or more of the superhydrophobic film modifier, the biocide potentiator, and the biocidal agent will be released in a controlled manner at a predetermined desired rate, e.g., that is appropriate for the sailing pattern of a ship.

For example, the polymers and/or copolymers that are used as binders in “self-polishing antifouling coatings” allowing the controlled release of one or more of the superhydrophobic film modifier, the biocide potentiator, and the biocidal agent may be hydrolysable acrylate polymers, such as (meth)acrylate based polymers and/or copolymers. The (meth)acrylate monomer moiety in a (meth)acrylate polymer and/or copolymer may be an alkyl (meth)acrylate, for example, a methyl (meth)acrylate, ethyl (meth)acrylate, propyl (meth)acrylate, isopropyl (meth)acrylate, butyl (meth)acrylate, isobutyl (meth)acrylate, tert-butyl (meth)acrylate, pentyl (meth)acrylate, hexyl (meth)acrylate, heptyl (meth)acrylate, cyclohexyl (meth)acrylate, octyl (meth)acrylate, iso-octyl (meth)acrylate, 2-ethylhexyl (meth)acrylate, 3,5,5-trimethylhexyl (meth)acrylate, lauryl (meth)acrylate, cetyl (meth)acrylate, and stearyl (meth)acrylate; phenyl (meth)acrylate; benzyl (meth)acrylate; an alkoxyalkyl (meth)acrylate, such as methoxymethyl (meth)acrylate, 2-methoxyethyl (meth)acrylate, ethoxymethyl (meth)acrylate, 2-ethoxyethyl (meth)acrylate, 4-methoxybutyl (meth)acrylate, methoxypropyl (meth)acrylate, ethoxypropyl (meth)acrylate, propoxyethyl (meth)acrylate, 2-butoxyethyl (meth)acrylate, isobutoxybutyl diglycol (meth)acrylate; a phenoxyethyl (meth)acrylate; a hydroxyalkyl (meth)acrylate, such as hydroxymethyl (meth)acrylate, 2-hydroxyethyl (meth)acrylate, 2-hydroxypropyl (meth)acrylate, 4-hydroxybutyl (meth)acrylate, or 2-hydroxy-3-phenoxypropyl (meth)acrylate; the (meth)acrylate monomer moiety in a (meth)acrylate polymer and/or copolymer may further be a silyl (meth)acrylate, such as tribenzylsilyl (meth)acrylate, trimethylsilyl (meth)acrylate, triethylsilyl (meth)acrylate, tri-isopropylsilyl (meth)acrylate, tri-n-butylsilyl (meth)acrylate, tri-isobutylsilyl (meth)acrylate, tri-t-butylsilyl (meth)acrylate, tri-n-amylsilyl (meth)acrylate, tri-n-dodecylsilyl (meth)acrylate, tri-n-hexylsilyl (meth)acrylate, tri-n-octylsilyl (meth)acrylate, tri-n-propylsilyl (meth)acrylate, or triphenylsilyl (meth)acrylate; the (meth)acrylate polymers and/or copolymers may also include a metal salt moiety of acrylic or methacrylic acid, referred to herein as a “metal salt (meth)acrylate.” The metal may be any suitable metal known to the skilled artisan, e.g., zinc, calcium, magnesium, lithium, iron, zirconium, aluminum, cobalt, zirconium, barium, and bismuth.

The polymer and/or copolymer allowing the controlled release of one or more of the superhydrophobic film modifier, the biocide potentiator, and the biocidal agent may also be a VAGH copolymer. The VAGH copolymer may be dissolved in 2:3 xylene:MIBK.

Thus, in one embodiment, the polymer and/or copolymer allowing the controlled release of one or more of the superhydrophobic film modifier, the biocide potentiator, and the biocidal agent includes a (meth)acrylate polymer and/or copolymer, or a VAGH copolymer. The (meth)acrylate polymer and/or copolymer may be a polymer or copolymer of monomer moieties selected from the group consisting of alkyl (meth)acrylate, phenyl (meth)acrylate, benzyl (meth)acrylate, alkoxyalkyl (meth)acrylate, hydroxyalkyl (meth)acrylate, zinc (meth)acrylates, and silyl-(meth)acrylate; or the (meth)acrylate polymer and/or copolymer may be a polymer or copolymer of monomer moieties selected from the group consisting of ethyl acrylate, methyl methacrylate, butyl acrylate, 2-methoxyethyl acrylate, zinc methacrylate, and tri-isopropylsilyl acrylate, preferably, the (meth)acrylate polymer and/or copolymer is a copolymer of monomer moieties selected from the group consisting of ethyl acrylate, methyl methacrylate, and zinc methacrylate, more preferably, the (meth)acrylate polymer polymer and/or copolymer is a copolymer of monomer moieties selected from the group consisting of ethyl acrylate, methyl methacrylate, 2-methoxyethyl acrylate and zinc methacrylate, and most preferably, the (meth)acrylate polymer polymer and/or copolymer is a copolymer of monomer moieties selected from the group consisting of methyl methacrylate, butyl acrylate, 2-methoxyethyl acrylate and tri-isopropylsilyl acrylate.

Consequently, example aspects of the invention further provide an antifouling paint include the additive composition and a polymer and/or copolymer allowing the controlled release of one or more of the superhydrophobic film modifier, the biocide potentiator, and the biocidal agent.

In antifouling paints according to example aspects of the present disclosure, the relative amounts of the superhydrophobic film modifier, the biocide potentiator, and the biocidal agent may vary depending on, e.g., the nature of the superhydrophobic film modifier, the nature of the biocide potentiator, and the nature of the biocidal agent. Advantageously, however, the biocide potentiator may be present in the antifouling paint from about 0.1 wt % to about 25 wt %, preferably from about 0.5 wt % to about 10 wt %, and more preferably from about 1 wt % to about 5 wt %. Additionally, the superhydrophobic film modifier may be present in the antifouling paint from about 0.2 wt % to about 20 wt %, preferably from about 0.5 wt % to about 10 wt %, and more preferably from about 1 wt % to about 5 wt %. The biocidal agent may be present in the antifouling paint at less than about 30 wt %. Such concentrations have been advantageously found to increase an efficacy of a primary biocidal agent, such as cuprous oxide, in the antifouling paints, which allows for lower amounts of the primary biocidal agent as relative to antifouling paints without the additive compositions. The total content of cuprous oxide in the antifouling paints according to example aspects of the invention may be less than about 50 wt %, more preferably less than about 40 wt %, and most preferably less than about 30 wt %. Thus, the copper content of the antifouling paints may be kept at a relatively low level.

The present invention further provides a method for inhibiting marine biofouling on a solid surface, characterized in that an antifouling paint including the additive composition is applied on the surface. The solid surface may be any solid surface of underwater objects, such as ships, an aquaculture fishnet, an underwater structure and equipment, a tank, an offshore construction, a pipe, a net, a pier, a pile or a pillar and the like.

The preceding description is exemplary in nature and is not intended to limit the scope, applicability or configuration of the disclosure in any way. Various changes to the described embodiments may be made in the function and arrangement of the elements described herein without departing from the scope of the disclosure.

Unless defined otherwise, all technical and scientific terms used herein have the same meaning as commonly understood by one of ordinary skill in the art to which this invention is related.

As used in this application and in the claims, the singular forms “a,” “an,” and “the” include the plural forms unless the context clearly dictates otherwise. Additionally, the term “includes” means “comprises.” The methods and compositions of the present disclosure, including components thereof, can comprise, consist of, or consist essentially of the essential elements and limitations of the embodiments described herein, as well as any additional or optional ingredients, components or limitations described herein or otherwise useful in biocidal compositions.

Unless otherwise indicated, all numbers expressing quantities of ingredients, properties such as molecular weight, percentages, and so forth, as used in the specification or claims are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is recited.

As used herein, “optional” or “optionally” means that the subsequently described material, event or circumstance may or may not be present or occur, and that the description includes instances where the material, event or circumstance is present or occurs and instances in which it does not. As used herein, “w/w %” and “wt %” means by weight as a percentage of the total weight or relative to another component in the composition.

The term “about” is intended to mean approximately, in the region of, roughly, or around. When the term “about” is used in conjunction with a numerical range, it modifies that range by extending the boundaries above and below the numerical values set forth. Unless otherwise indicated, it should be understood that the numerical parameters set forth in the following specification and attached claims are approximations. At the very least, and not as an attempt to limit the application of the doctrine of equivalents to the scope of the claims, numerical parameters should be read in light of the number of reported significant digits and the application of ordinary rounding techniques.

The term “substantially free of” when used to describe the amount of substance in a material is not to be limited to entirely or completely free of and may correspond to a lack of any appreciable or detectable amount of the recited substance in the material. Thus, e.g., a material is “substantially free of” a substance when the amount of the substance in the material is less than the precision of an industry-accepted instrument or test for measuring the amount of the substance in the material. In certain example embodiments, a material may be “substantially free of” a substance when the amount of the substance in the material is less than 10%, less than 9%, less than 8%, less than 7%, less than 6%, less than 5%, less than 4%, less than 3%, less than 2%, less than 1%, less than 0.5%, or less than 0.1% by weight of the material.

The phrase “effective amount” means an amount of a compound that promotes, improves, stimulates, or encourages a response to the particular condition or disorder or the particular symptom of the condition or disorder.

The term “potentiator” as used herein refers to an additive that can affect the performance of an active compound when used in combination with the active compound but does not exhibit any biocidal activity itself and/or does not exhibit significant biocidal activity itself in the compositions of the invention.

The term “biocidal agent” as used herein refers to any chemical compound that prevents the settlement of marine organisms on a surface and/or prevents the growth of marine organisms on a surface and/or encourages the dislodgement of marine organisms from a surface.

The terms “antifouling paint” and “antifouling coating” are used interchangeably herein.

As used herein, references to chemical formulas use standard element symbols according to the periodic table (e.g., C denotes carbon, N denotes nitrogen, etc.) Further, references to chemical formula are based on standard bonding such that carbon can make up to four (4) bonds and nitrogen can make up to three (3) bonds unless otherwise specified.

Throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

In the following, the present invention will be further described with reference to Examples, but should be construed that the present invention is in no way limited to these Examples.

### Example

It will be understood that the antifouling paints described in the Examples may be substantially free of any substance not expressly described.

In order to confirm that the efficacy of the additive compositions in allowing significant reduction in the amount of cuprous oxide needed for antifouling purposes, the efficacy of a set of ablative antifouling paints was evaluated by immersing experimental painted panels in seawater on a test raft.

Various ablative antifouling paints were prepared for this purpose: without any biocidal agent and without any additive composition (“negative control paint”); with only cuprous oxide as the biocidal agent and without any additive composition (“positive control paint”); with only cuprous oxide and the secondary biocidal agent as the biocidal agents; with only cuprous oxide and the biocide potentiator as the biocidal agents; with only cuprous oxide and the superhydrophobic film modifier as the biocidal agents; and with cuprous oxide and various combinations of the superhydrophobic film modifier, the biocide potentiator, and the secondary biocidal agent.

The antifouling components within the antifouling paints employed in this example are depicted in Table 1 below. The paints have been applied to rectangular, fiberglass panels as follows. Each panel was coated front and back with the respective paints at different concentrations of cuprous oxide. The coated panels were submerged within salt water and supported by floating racks. The panels were inspected after immersion at two months (Table 2), four months (Table 3), six months (Table 4), and eighteen months (Table 5). Testing was based on a modified ASTM standard rating (D 6990-05). A fouling rating between 1 and 10 was assigned to each side of the panels, with a 10 rating corresponding to no or 0% fouling, a 0 rating corresponding to complete or 100% fouling, and intervening ratings corresponding to respective proportional fouling. During inspection, the panels were rinsed and kept wet with water from the test site. Panel edges and mounting holes were not considered while assigning the fouling ratings.

TABLE 1
Antifouling components of the antifouling paints and control paint

| | Cu₂O | Film | Biocide | Secondary |
|---|---|---|---|---|
| Sample # | (Front/Rear) | Modifier | Potentiator | Biocide |
| 1 | 40%/25% | 0% | 0% | 0% |
| 2 | 0% | 0% | 0% | 0% |
| 3 | 40%/25% | 0% | 0% | 5% |
| 4 | 40%/25% | 0% | 0% | 3% |
| 5 | 40%/25% | 0% | 0% | 2% |
| 6 | 40%/25% | 0% | 9% | 0% |
| 7 | 40%/25% | 0% | 6% | 0% |
| 8 | 40%/25% | 0% | 3% | 0% |
| 9 | 40%/25% | 9% | 0% | 0% |
| 10 | 40%/25% | 9% | 0% | 0% |
| 11 | 40%/25% | 6% | 0% | 0% |
| 12 | 40%/25% | 3% | 0% | 0% |
| 13 | 40%/25% | 3% | 4% | 2% |
| 14 | 40%/25% | 3% | 4% | 2% |
| 15 | 40%/25% | 2% | 3% | 1% |
| 16 | 40%/25% | 1% | 1% | 1% |

It will be understood that the ingredients listed in Table 1 correspond to the antifouling components within the antifouling paints, namely the primary biocidal agent (cuprous oxide), the superhydrophobic film modifier (modified silicate and aluminosilicate particle), the biocide potentiator (copper di(ethyl 4,4,4-trifluoroacetoacetate)), and the secondary biocidal agent (4,5-dichloro-2-n-octyl-4-isothiazolin-3-one (DCOIT)). Without being bound to any particular theory, the antifouling components within the antifouling paints are believed to correspond to the ingredients that prevent settlement of marine organisms on a surface and/or prevent the growth of marine organisms on the surface and/or encourage the dislodgement of marine organisms from the surface of the substrate. Inactive components make up the remainder of the antifouling paints. The inactive components include gum rosin, Laroflex® MP25 (copolymer of vinyl chloride and vinyl isobutyl ether), chlor.paraffin/Disperbyk 161 (a dispersing additive), talc, red iron oxide, zinc oxide, Disparlon A650-20× (synthetic polyamide wax dispersion), Bentone 38 (an organo clay added for anti-settling properties), and xylene.

TABLE 2
Two Month Testing

| | Hard | Hard | Soft | Soft |
|---|---|---|---|---|
| | Fouling | Fouling | Fouling | Fouling |
| | Rating | Rating | Rating | Rating |
| Sample # | (Front) | (Rear) | (Front) | (Rear) |
| 1 | 9.5 | 9.5 | 9.5 | 9.5 |
| 2 | 5.5 | 6.5 | 8.0 | 7.0 |
| 3 | 9.8 | 9.5 | 9.5 | 9.5 |
| 4 | 9.5 | 9.75 | 9.5 | 9.5 |
| 5 | 9.5 | 9.5 | 9.5 | 9.5 |
| 6 | 9.5 | 9.5 | 9.5 | 9.5 |
| 7 | 9.5 | 9.75 | 9.5 | 9.5 |
| 8 | 9.5 | 9.75 | 9.5 | 9.5 |
| 9 | 9.5 | 9.5 | 9.5 | 9.5 |
| 10 | 9.5 | 9.5 | 9.5 | 9.5 |
| 11 | 9.5 | 9.5 | 9.5 | 9.5 |
| 12 | 9.5 | 9.5 | 9.5 | 9.5 |
| 13 | 9.8 | 9.75 | 9.5 | 9.5 |
| 14 | 10.0 | 9.75 | 9.5 | 9.5 |
| 15 | 9.5 | 9.5 | 9.5 | 9.5 |
| 16 | 9.5 | 9.5 | 9.5 | 9.5 |

TABLE 3
Four Month Testing

| | Hard | Hard | Soft | Soft |
|---|---|---|---|---|
| | Fouling | Fouling | Fouling | Fouling |
| | Rating | Rating | Rating | Rating |
| Sample # | (Front) | (Rear) | (Front) | (Rear) |
| 1 | 8.8 | 9.3 | 8.3 | 9.3 |
| 2 | 2.0 | 2.5 | 2.0 | 2.5 |
| 3 | 9.3 | 9.5 | 9.3 | 9.5 |
| 4 | 9.3 | 9.3 | 9.3 | 9.5 |
| 5 | 9.3 | 9.3 | 9.3 | 8.5 |
| 6 | 9.5 | 9.5 | 9.0 | 8.0 |
| 7 | 9.5 | 9.5 | 8.5 | 7.5 |
| 8 | 9.5 | 9.5 | 8.3 | 8.8 |
| 9 | 9.0 | 9.3 | 8.0 | 8.5 |
| 10 | 9.0 | 9.3 | 8.8 | 8.5 |
| 11 | 9.3 | 9.5 | 8.5 | 8.3 |
| 12 | 9.3 | 9.5 | 8.5 | 8.3 |
| 13 | 9.5 | 9.5 | 9.0 | 9.0 |
| 14 | 9.5 | 9.5 | 9.0 | 9.5 |
| 15 | 9.3 | 9.3 | 9.0 | 9.5 |
| 16 | 9.0 | 9.5 | 9.0 | 9.5 |

TABLE 4
Six Month Testing

| | Hard | Hard | Soft | Soft |
|---|---|---|---|---|
| | Fouling | Fouling | Fouling | Fouling |
| | Rating | Rating | Rating | Rating |
| Sample # | (Front) | (Rear) | (Front) | (Rear) |
| 1 | 6.0 | 8.8 | 3.8 | 4.5 |
| 2 | 0.0 | 0.0 | 0.0 | 0.0 |
| 3 | 8.8 | 9.3 | 6.3 | 8.5 |
| 4 | 8.5 | 8.8 | 7.5 | 8.5 |
| 5 | 7.5 | 9.5 | 6.8 | 7.5 |
| 6 | 6.3 | 9.5 | 6.0 | 4.5 |
| 7 | 7.8 | 8.8 | 5.3 | 4.5 |
| 8 | 7.3 | 8.8 | 5.8 | 5.5 |
| 9 | 4.5 | 7.8 | 5.8 | 3.5 |
| 10 | 3.8 | 8.3 | 5.3 | 3.5 |
| 11 | 5.5 | 6.3 | 4.0 | 4.0 |
| 12 | 5.8 | 7.3 | 5.0 | 4.8 |
| 13 | 8.5 | 7.0 | 7.5 | 5.3 |
| 14 | 9.5 | 9.5 | 8.0 | 6.5 |
| 15 | 7.5 | 5.5 | 7.8 | 3.8 |
| 16 | 5.5 | 4.5 | 7.8 | 1.8 |

TABLE 5
Eighteen Month Testing

| | Hard | Hard | Soft | Soft |
|---|---|---|---|---|
| | Fouling | Fouling | Fouling | Fouling |
| | Rating | Rating | Rating | Rating |
| Sample # | (Front) | (Rear) | (Front) | (Rear) |
| 1 | 7.5 | 8.0 | 4.0 | 5.5 |
| 2 | 0.0 | 0.0 | 0.0 | 0.0 |
| 3 | 7.5 | 7.5 | 8.0 | 7.5 |
| 4 | 7.5 | 8.0 | 6.0 | 6.0 |
| 5 | 6.5 | 7.5 | 5.0 | 6.0 |
| 6 | 7.5 | 8.0 | 4.0 | 6.0 |
| 7 | 8.0 | 8.5 | 4.0 | 5.5 |
| 8 | 7.5 | 8.5 | 4.0 | 5.5 |
| 9 | 5.5 | 6.5 | 4.0 | 4.5 |
| 10 | 5.0 | 7.0 | 5.0 | 5.0 |
| 11 | 7.0 | 8.0 | 4.0 | 3.5 |
| 12 | 7.5 | 8.0 | 4.0 | 4.5 |
| 13 | 8.5 | 8.0 | 6.0 | 6.5 |
| 14 | 8.5 | 9.0 | 6.0 | 7.5 |
| 15 | 7.5 | 7.0 | 5.0 | 6.5 |
| 16 | 7.0 | 6.5 | 4.0 | 5.0 |

The panels that include additive compositions each exhibit desirable antifouling performance. A general trend that all evaluated additive compositions improve the performance of antifouling paints is observed. In particular, the panels coated that include additive compositions may exhibit desirable antifouling performance for both the front side (with 40% cuprous oxide) and the rear side (with 25% cuprous oxide). Thus, it has been observed that the additive compositions allow significant reduction in the amount of cuprous oxide needed for antifouling purposes.

These and other modifications and variations to the present disclosure may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1. An additive composition for an antifouling coating, comprising:
a superhydrophobic film modifier; and
a biocide potentiator comprising one or both of a compound IA and a compound IB,
wherein the compound IA has the following formula 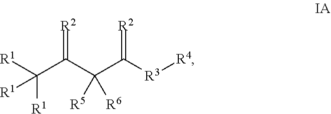
wherein the compound IB has the following formula 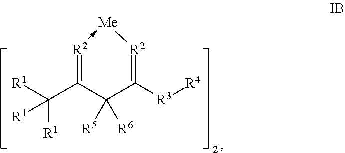
wherein Me is Cu, Zn, Co, Ni, Ca, Mg, or Mn,
wherein R1 is each independently selected from hydrogen, halogen, linear or branched C₁₋₂₀ alkyl, C₂₋₂₀ alkenyl, C₂₋₂₀ alkynyl, C₃₋₁₂ cycloalkyl, C₆₋₂₀ aryl, and C₇₋₂₀ arylalkyl,
wherein R2 is each independently selected from NH, O, S, and Se,
wherein R3 is NH, N(R4), O, S, or Se,
wherein R4 is hydrogen, linear or branched C₁₋₂₀ alkyl, C₂₋₂₀ alkenyl, C₂₋₂₀ alkynyl, C₃₋₁₂ cycloalkyl, C₆₋₂₀ aryl, or C₇₋₂₀ arylalkyl, and
wherein R5 and R6 are each independently selected from H, linear or branched C₁₋₂₀ alkyl, C₂₋₂₀ alkenyl, C₂₋₂₀ alkynyl, C₃₋₁₂ cycloalkyl, C₆₋₂₀ aryl, and C₇₋₂₀ arylalkyl, or R5 and R6 together form a group ═O, ═S, ═Se, ═NR4, ═C(R4) 2, ═C(R4)(OR4), ═C(R4)(NHR4).

2. The additive composition of claim 1, wherein:
Me is Cu or Zn;
R1 is each independently selected from H, F, methyl, ethyl, n-propyl, i-propyl, n-butyl, i-butyl, tert-butyl, cyclo-butyl, cyclo-pentyl, cyclo-hexyl, C₈ alkyl, C₉ alkyl, C₁₀ alkyl, C₁₁ alkyl, C₁₂ alkyl, and benzyl;
R2 is each independently selected from NH and O;
R3 is N(R4) or O;
R4 is H, methyl, ethyl, n-propyl, i-propyl, n-butyl, i-butyl, tert-butyl, cyclo-butyl, cyclo-pentyl, cyclo-hexyl, C₈ alkyl, C₉ alkyl, C₁₀ alkyl, C₁₁ alkyl, C₁₂ alkyl, or benzyl; and
R5 and R6 are each independently selected from H, methyl, ethyl, n-propyl, i-propyl, n-butyl, i-butyl, tert-butyl, and benzyl, or R5 and R6 together form a group ═CH(OCH₃), ═CH(OC₂H₅), ═CH(OnC₃H₇), ═CH(OiC₃H₇), ═CH(OnC₄H₉), ═CH(OiC₄H₉), ═CH(OtertC₄H₉), ═CH(NHCH₃), ═CH(NHC₂H₅), ═CH(NHnC₃H₇), ═CH(NHiC₃H₇), ═CH(NHnC₄H₉), ═CH(NHiC₄H₉), or ═CH(NHtertC₄H₉).

3. The additive composition of claim 1, wherein a ratio of the superhydrophobic film modifier to the biocide potentiator by weight is from 10:1 to 1:10, preferably from 5:1 to 1:5, and most preferably from 3:1 to 1:3.

4. The additive composition of claim 1, further comprising a biocidal agent.

5. The additive composition of claim 4, wherein the biocidal agent comprises one or more of copper 2-pyridinethiol-1-oxide (copper pyrithione, CuPT), zinc 2-pyridinethiol-1-oxide (zinc pyrithione, ZnPT), 4,5-dichloro-2-n-octyl-4-isothiazolin-3-one (DCOIT), cuprous oxide (Cu₂O), zinc oxide (ZnO), 4-bromo-2-(4-chlorophenyl)-5-(trifluoromethyl)-1H-pyrrole-3-carbonitrile (tralopyril), zinc ethane-1,2-diylbis(dithiocarbamate)(zineb), zinc N,N-dimethylcarbamodithioate (ziram), 3-(3,4-dichlorophenyl)-1,1-dimethylurea (diuron), copper (I) thiocyanate (CuSCN), 4-[1-(2,3-dimethylphenyl)ethyl]-1H-imidazole (medetomidine), triazines, fluanids, and 2,4,5,6-tetrachloroisophthalonitrile (chlorothalonil).

6. The additive composition of claim 4, wherein a ratio of the biocide potentiator to the biocidal agent by weight is from 10:1 to 1:10, preferably from 5:1 to 1:5, and most preferably from 1:1 to 1:3.

7. The additive composition of claim 1, wherein the superhydrophobic film modifier comprises porous diatomaceous earth particles coated with a hydrophobic layer.

8. A method, comprising using the additive composition of claim 1 for inhibition of marine biofouling on a solid surface.

9. The method of claim 8, wherein the antifouling composition is used in combination with a polymer, a copolymer, or both the polymer and the copolymer to allow controlled release of one or both of the superhydrophobic film modifier and the biocide potentiator.

10. An antifouling paint, comprising:
the additive composition of claim 1; and
a polymer, a copolymer, or both the polymer and the copolymer to allow controlled release of the one or more of the superhydrophobic film modifier, the biocide potentiator, and the biocidal agent.

11. The antifouling paint of claim 10, wherein the biocide potentiator is present in the antifouling paint from about 0.2 wt % to about 20 wt %, preferably from about 0.5 wt % to about 10 wt %, and more preferably from about 1 wt % to about 5 wt %.

12. The antifouling paint of claim 1, wherein the biocidal agent is present in the antifouling paint at less than about 30 wt %.

13. The antifouling paint of claim 1, wherein the superhydrophobic film modifier is present in the antifouling paint from about 0.2 wt % to about 20 wt %, preferably from about 0.5 wt % to about 10 wt %, and more preferably from about 1 wt % to about 5 wt %.

14. The antifouling paint of claim 1, wherein the antifouling paint is not superhydrophobic.

15. A method for inhibiting marine biofouling on a solid surface, comprising applying the antifouling paint of claim 1 onto the solid surface.
